(19) United States
(12) Patent Application Publication
(10) Pub. No.: US 2007/0177668 A1
(43) Pub. Date: Aug. 2, 2007

(54) Method of and apparatus for deciding intraprediction mode

(75) Inventor: Min-kyu Park, Dongjak-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/657,443

(22) Filed: Jan. 25, 2007

(30) Foreign Application Priority Data
Feb. 2, 2006 (KR) 10-2006-0010180

(51) Int. Cl. H04N 7/12; H04N 11/04

(52) U.S. Cl. 375/240.12; 375/240.24

(57) ABSTRACT

A method of and apparatus are provided for deciding an intraprediction mode, in which pixels of an input block are labeled according to their pixel values and a directivity is extracted from pixels having the same label to decide the intraprediction mode. The method includes assigning labels to the pixels of the input block according to the pixel values of the pixels, scanning the labeled input block according to a scan table and calculating mode counts of intraprediction modes by counting the intraprediction mode if the pixels at predetermined positions according to a direction of the intraprediction mode are assigned the same label, and deciding the intraprediction mode for the input block using the calculated mode counts.

### CROSS-REFERENCE TO RELATED PATENT APPLICATION

This application claims priority from Korean Patent Application No. 10-2006-0010180, filed on Feb. 2, 2006, in the Korean Intellectual Property Office, the disclosure of which is incorporated herein in its entirety by reference.

### BACKGROUND OF THE INVENTION

1. Field of the Invention

The present invention relates to a method of and apparatus for deciding a prediction mode in the intraprediction of a video, and more particularly, to a method of and apparatus for deciding an intraprediction mode, in which pixels of an input block are labeled according to their pixel values and a directivity is extracted from pixels having the same label to decide the intraprediction mode.

2. Description of the Related Art

According to H.264/moving picture experts group (MPEG)-4 advanced video coding (AVC), a picture is divided into macroblocks for video encoding. After each of the macroblocks is encoded in all interprediction and intraprediction encoding modes, an appropriate encoding mode is selected according to the bit rate required for encoding the macroblock and the allowable distortion between the original macroblock and the decoded macroblock. Then the macroblock is encoded in the selected encoding mode.

In intraprediction, a prediction value of a macroblock to be encoded is calculated using the value of a pixel that is spatially adjacent to the macroblock to be encoded, and the difference between the prediction value and the pixel value is encoded when encoding macroblocks of the current picture. Intraprediction modes can be roughly divided into 4×4 intraprediction modes and 16×16 intraprediction modes.

FIG. 1 illustrates 16×16 intraprediction modes according to the H.264 standard, and FIG. 2 illustrates 4×4 intraprediction modes according to the H.264 standard.

Referring to FIG. 1, there are four 16×16 intraprediction modes, i.e., a vertical mode, a horizontal mode, a direct current (DC) mode, and a plane mode. Referring to FIG. 2, there are nine 4×4 intraprediction modes, i.e., a vertical mode, a horizontal mode, a DC mode, a diagonal down-left mode, a diagonal down-right mode, a vertical right mode, a vertical left mode, a horizontal up mode, and a horizontal down mode.

For example, when a 4×4 current block is prediction encoded in a mode 0, i.e., the vertical mode of FIG. 2, pixel values of pixels A through D adjacent above the 4×4 current block are predicted to be the pixel values of the 4×4 current block. In other words, the pixel value of the pixel A is predicted to be the pixel values of the four pixels of the first column of the 4×4 current block, the pixel value of the pixel B is predicted to be the pixel values of the four pixels of the second column of the 4×4 current block, the pixel value of the pixel C is predicted to be the pixel values of the four pixels of the third column of the 4×4 current block, and the pixel value of the pixel D is predicted to be the pixel values of the four pixels of the fourth column of the 4×4 current block. Next, the difference between the pixel values of pixels of the 4×4 current block predicted using the pixels A through D and the actual pixel values of pixels included in the original 4×4 current block is obtained and encoded.

In video encoding according to H.264/AVC, rate-distortion optimization (RDO) is used to decide the optimal prediction mode. In other words, to decide the optimal prediction mode in encoding, intraprediction is performed in all the prediction modes and a prediction mode exhibiting the best RDO performance is decided. According to the related art, intraprediction is performed in all the prediction modes to decide the optimal prediction mode, resulting in a large amount of computation. For example, if intraprediction is performed on each 4×4 input block of a 720×480 image at 30 frames per second (fps) and the number of I frames that are intrapredicted per second is 10, 9 intraprediction modes are used per second, resulting in a total of 1,944,000 ((720/4)×(480/4)×9×10) computations for intraprediction. As such, according to the related art, a large amount of computation is required for intraprediction, making it difficult to implement a real-time video encoder.

### SUMMARY OF THE INVENTION

The present invention provides a method of and apparatus for deciding an intraprediction mode, in which a directivity is extracted using pixel information within an input block in intraprediction and computational complexity is reduced in the decision of an intraprediction mode.

According to one aspect of the present invention, there is provided a method of deciding an intraprediction mode of a video. The method includes (a) assigning labels to pixels of an input block according to pixel values of the pixels, (b) scanning the labeled input block according to a scan table and calculating mode counts of intraprediction modes by counting the intraprediction mode if pixels at predetermined positions according to a direction of the intraprediction mode are assigned the same label, and (c) deciding the intraprediction mode for the input block using the calculated mode counts.

According to another aspect of the present invention, there is provided an apparatus for deciding an intraprediction mode of a video. The apparatus includes a labeling unit, a scanning unit, and a prediction mode decision unit. The labeling unit assigns labels to pixels of an input block according to pixel values of the pixels. The scanning unit scans the labeled input block according to a scan table and calculates mode counts of intraprediction modes by counting the intraprediction mode if the pixels at predetermined positions according to a direction of the intraprediction mode are assigned the same label. The prediction mode decision unit decides the intraprediction mode for the input block using the calculated mode counts.

### BRIEF DESCRIPTION OF THE DRAWINGS

The above and other aspects of the present invention will become more apparent by describing in detail exemplary embodiments thereof with reference to the attached drawings in which:

FIG. 1 illustrates 16×16 intraprediction modes according to the H.264 standard;

FIG. 2 illustrates 4×4 intraprediction modes according to the H.264 standard;

FIG. 3 is a flowchart illustrating a method of deciding an intraprediction mode according to an exemplary embodiment of the present invention;

FIG. 4 is a detailed flowchart illustrating operation 310 of FIG. 3;

FIG. 5 illustrates division of pixel values according to an exemplary embodiment of the present invention;

FIGS. 6A and 6B illustrate a process of labeling each of pixels of an input block according to an exemplary embodiment of the present invention;

FIG. 7 is a detailed flowchart illustrating operation 320 of FIG. 3;

FIG. 8 illustrates positions of pixels of an input block used in an exemplary embodiment of the present invention;

FIG. 9 illustrates directions of intraprediction modes according to an exemplary embodiment of the present invention;

FIGS. 10 and 11 are views for explaining a process of counting intraprediction modes according to an exemplary embodiment of the present invention;

FIG. 12 is a detailed flowchart illustrating operation 330 of FIG. 3;

FIG. 13 is a block diagram of a video encoder to which an apparatus for deciding an intraprediction mode according to an exemplary embodiment of the present invention is applied; and

FIG. 14 is a block diagram of an apparatus for deciding an intraprediction mode according to an exemplary embodiment of the present invention.

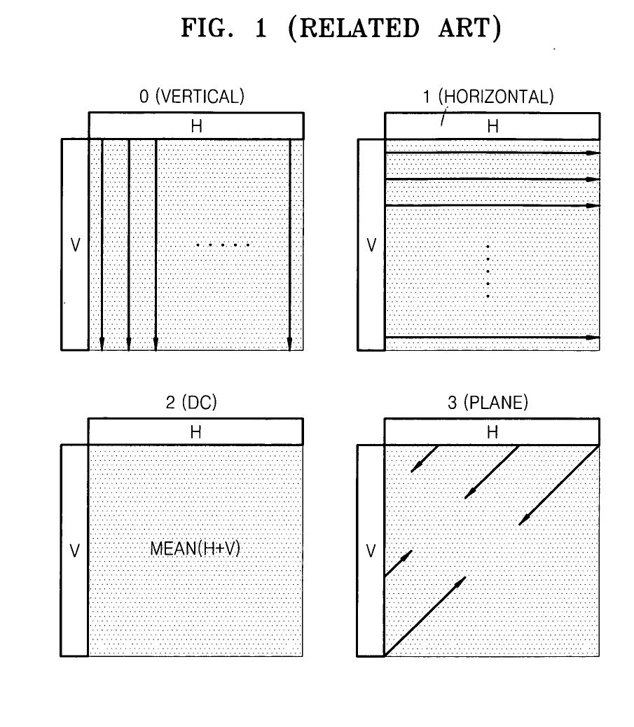

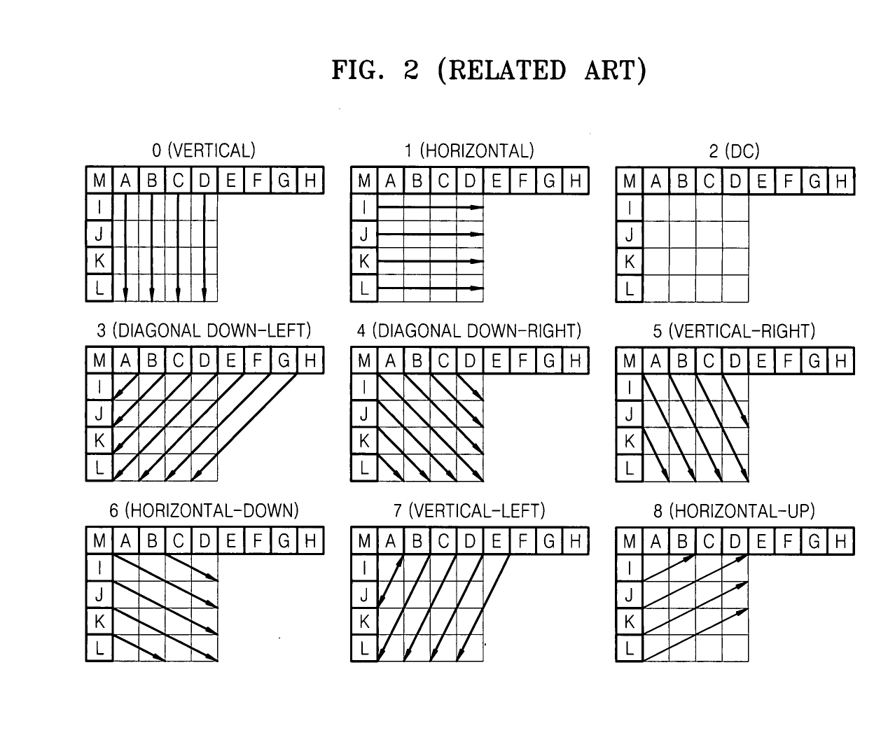

### DETAILED DESCRIPTION OF EXEMPLARY EMBODIMENTS OF THE INVENTION

Hereinafter, exemplary embodiments of the present invention will be described in detail with reference to the accompanying drawings.

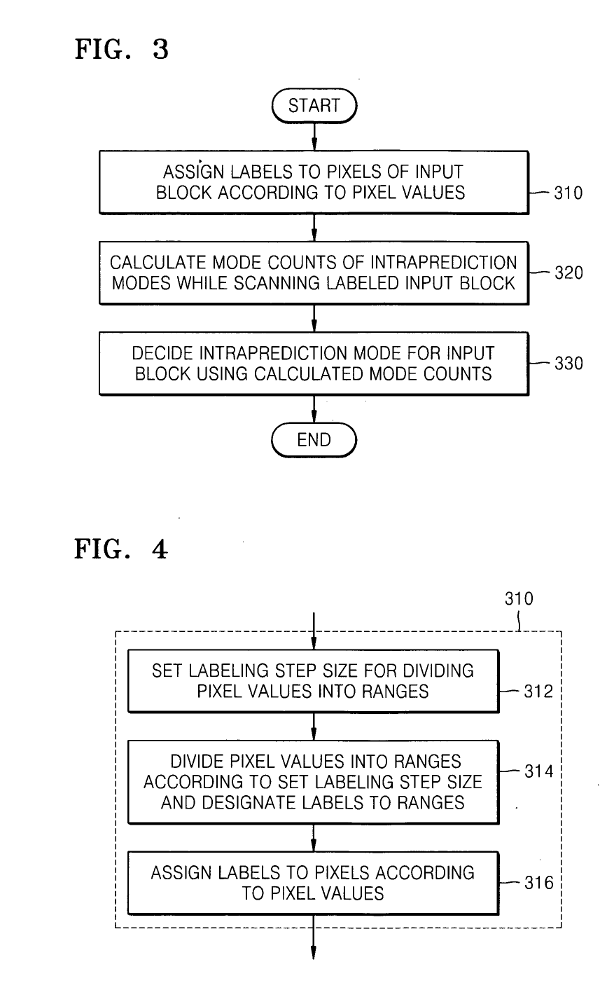

FIG. 3 is a flowchart illustrating a method of deciding an intraprediction mode according to an exemplary embodiment of the present invention.

The method of deciding an intraprediction mode is characterized in that pixels of an input block are labeled according to the magnitude of their pixel values, a directivity in the input block is detected by determining whether labels assigned to pixels at predetermined positions are the same according to directions of intraprediction modes available in the input block, and the optimal intraprediction mode is decided using the detected directivity. In particular, in the exemplary embodiment of the present invention, instead of generating a prediction block using all intraprediction modes and deciding the optimal intraprediction mode having the minimum cost using a difference between the prediction block and the original block, the optimal intraprediction mode is decided using pixel values of the input block, thereby reducing the amount of computation. For convenience of explanation, it is assumed that the size of the input block is 4×4 or 5×5. Although there is no provision regarding a 5×5 input block in the H.264 standard, a directivity in the input block can be efficiently predicted using a 5×5 input block formed by adding neighboring pixels located above and to the left of a 4×4 input block, based on the fact that the neighboring pixels are used in the intraprediction of the 4×4 input block. However, the present invention can also be applied to the intraprediction of blocks of various sizes as well as 4×4 or 5×5 input blocks.

Referring to FIG. 3, pixels of the input block are labeled according to the magnitude of their pixel values in operation 310. In operation 320, the labeled block is scanned and a mode count is calculated for each intraprediction mode. In operation 330, the optimal intraprediction mode is decided using the calculated mode count for each intraprediction mode. Hereinafter, each operation will be described in detail.

FIG. 4 is a detailed flowchart illustrating operation 310 of FIG. 3.

Referring to FIG. 4, a labeling step size is set in order to label the pixels of the input block in operation 312. For example, luminances (Y) in a YUV-format image ranges 0-255. In this case, if the labeling step size is set to 10, the luminances can be expressed using a total of 25 labels. The labeling step size may be changed, if necessary. However, if the labeling step size is too large, the elaborateness of the labels assigned to the pixels of the input block is degraded, resulting in a high possibility of assigning similar labels to the pixels of the input block and thus deciding a DC mode for the optimal intraprediction mode. If the labeling step size is too small, it is difficult to detect a directivity from the input block.

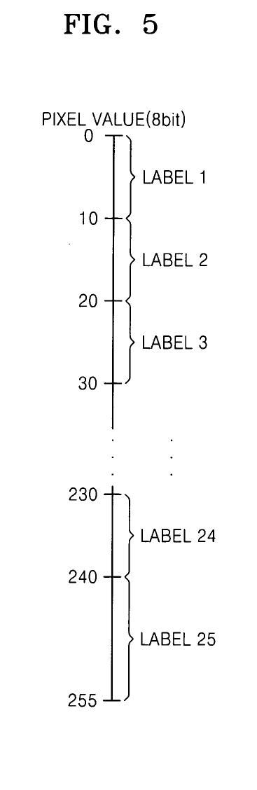

In operation 314, the pixel values of the input block are divided into several ranges according to the set labeling step size and labels are designated for the ranges. Referring to FIG. 5, when the labeling step size is set to 10, the pixel values 0-255 are divided into a total of 25 ranges and a label is designated for each of the ranges. The labels are assigned to the pixels of the input block in order to detect similar regions among the pixels of the input block and detect a directivity in the input block by scanning pixels having the same label. For a range that does not match with the labeling step size, i.e., the range of pixel values 240-255, such a range may be sub-divided or the last range of the pixel values may be different from the set labeling step size.

In operation 316, a range to which a pixel value of each of the pixels of the input block belongs is determined and a label designated for the determined range is assigned to each of the pixels.

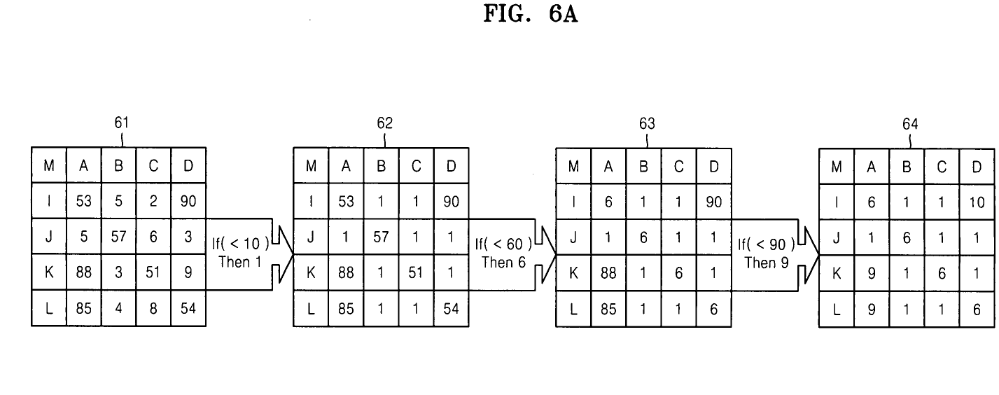

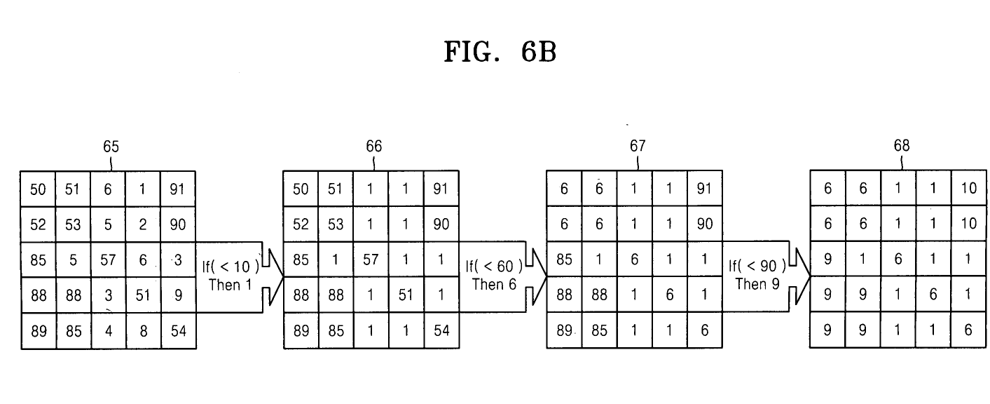

FIGS. 6A and 6B illustrate a process of labeling each of the pixels of the input block according to an exemplary embodiment of the present invention. Here, FIG. 6A illustrates a process of assigning labels to a 4×4 input block, and FIG. 6B illustrates a process of assigning labels to a 5×5 input block.

Referring to FIGS. 6A and 6B, if the labeling step size is 10 and pixel values of the input block are indicated by P, a label 1 is assigned to pixels satisfying P<10, a label 2 is assigned to pixels satisfying 10<=P<20, . . . , and a label 25 is assigned to pixels satisfying 240<=P<=255. In this way, pixels of the original input blocks 61 and 65 are labeled according to ranges to which pixel values of the pixels belong, and thus, labeled blocks 64 and 68 are generated.

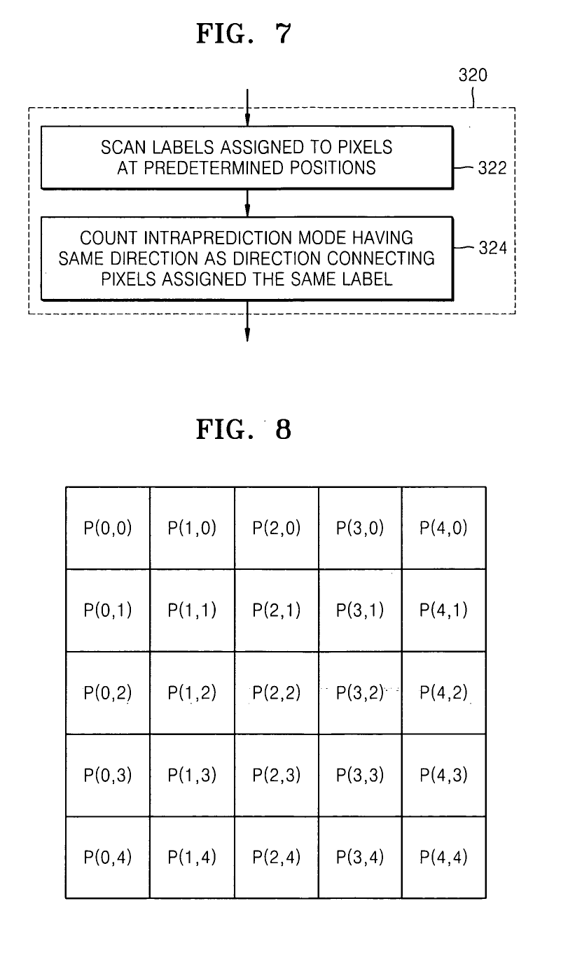

FIG. 7 is a detailed flowchart illustrating operation 320 of FIG. 3.

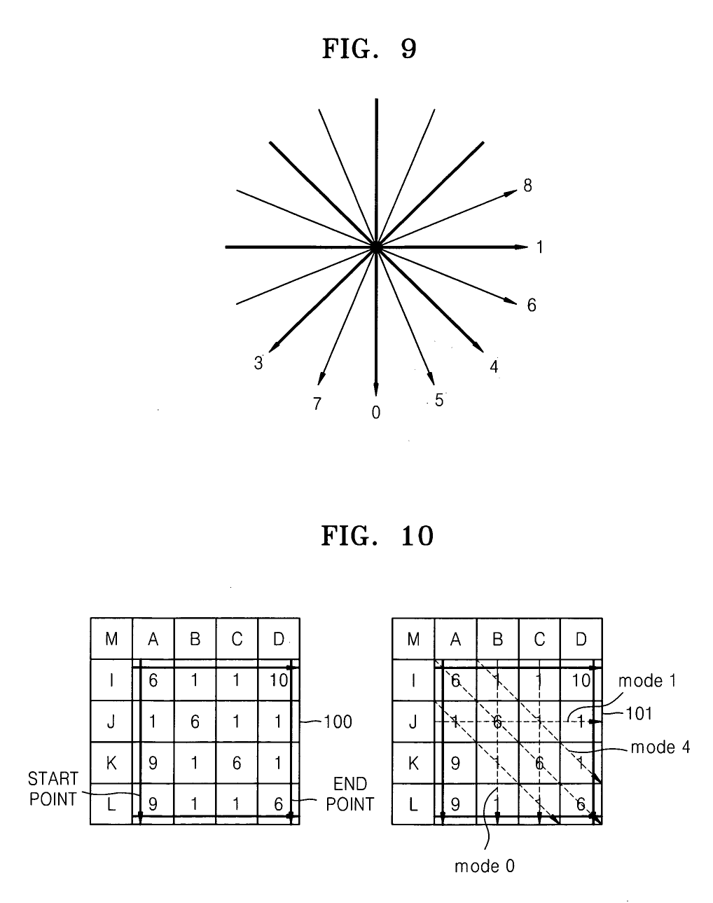

Referring to FIG. 7, after labels are assigned to the pixels of the input block in operation 310, the labels assigned to the pixels of the input block are scanned according to a predetermined scan table in operation 322. The scan table specifies the start point and the end point of scanning in the input block based on directions of intraprediction modes. The start point is at one of pixels included in the first column and row of the input block and the end point is at one of pixels included in the last column and row of the input block. If a position of a pixel located at an x-th column and a y-th row of the input block is expressed by P(x, y) as illustrated in FIG. 8 and the directions of intraprediction modes are as illustrated in FIG. 9, the labels assigned to the pixels of the input block are scanned for each of the intraprediction modes according to a scan table, such as Table 1 or Table 2. Here, Table 1 is a scan table for a 5×5 input block and Table 2 is a scan table for a 4×4 input block. Table 1 and Table 2 are only an example of the scan table and may be changed according to the directions of the intraprediction modes.

TABLE 1

| Mode 0 | | Mode 1 | | Mode 3 | | Mode 4 | |
|---|---|---|---|---|---|---|---|
| Start | End | Start | End | Start | End | Start | End |
| P(0, 0) | P(0, 4) | P(0, 0) | P(4, 0) | P(2, | P(0, 2) | P(0, 0) | P(4, 4) |
| | | | | 0) | | | |
| P(1, 0) | P(1, 4) | P(1, 0) | P(4, 0) | P(3, | P(0, 3) | P(1, 0) | P(4, 3) |
| | | | | 0) | | | |
| P(2, 0) | P(2, 4) | P(2, 0) | P(4, 0) | P(4, | P(0, 4) | P(2, 0) | P(4, 2) |
| | | | | 0) | | | |
| P(3, 0) | P(3, 4) | P(0, 1) | P(4, 1) | | | P(3, 0) | P(4, 1) |
| P(4, 0) | P(4, 4) | P(0, 2) | P(4, 2) | | | P(0, 1) | P(3, 4) |
| P(0, 1) | P(0, 4) | P(0, 3) | P(4, 3) | | | P(0, 2) | P(2, 4) |
| P(0, 2) | P(0, 4) | P(0, 4) | P(4, 4) | | | P(0, 3) | P(1, 4) |

TABLE 2

| Mode 0 | | Mode 1 | | Mode 3 | | Mode 4 | |
|---|---|---|---|---|---|---|---|
| Start | End | Start | End | Start | End | Start | End |
| P(0, 0) | P(0, 3) | P(0, 0) | P(3, 0) | P(2, | P(0, 2) | P(0, 0) | P(3, 3) |
| | | | | 0) | | | |
| P(1, 0) | P(1, 3) | P(1, 0) | P(3, 0) | P(3, | P(0, 3) | P(1, 0) | P(3, 2) |
| | | | | 0) | | | |
| P(2, 0) | P(2, 3) | P(0, 1) | P(3, 1) | | | P(0, 1) | P(2, 3) |
| P(3, 0) | P(3, 3) | P(0, 2) | P(3, 2) | | | P(0, 2) | P(1, 3) |
| P(0, 1) | P(0, 3) | P(0, 3) | P(3, 3) | | | | |

In the exemplary embodiment of the present invention, scanning is performed in the horizontal mode (Mode 0), the vertical mode (Mode 1), the diagonal down-left mode (Mode 3), and the diagonal down-right mode (Mode 4) among 9 intraprediction modes illustrated in FIG. 9. To improve the accuracy of prediction, once the optimal intraprediction mode is decided, modes adjacent to the decided intraprediction mode may be additionally selected.

Next, labels assigned to two pixels corresponding to the start point and the end point are read according to the scan table, and if the read labels are the same, an intraprediction mode having the same direction as a direction connecting the two pixels is counted in operation 324.

FIGS. 10 and 11 are views for explaining a process of counting intraprediction modes while scanning labels assigned to pixels according to a predetermined scan table. In FIGS. 10 and 11, labeled input blocks 100 and 110 correspond to the labeled blocks 64 and 68 of FIGS. 6A and 6B, respectively.

Referring to FIG. 10, labels assigned to pixels at predetermined positions in a 4×4 input block are scanned according to the scan table, e.g., Table 2, and if the scanned two pixels have the same label, a corresponding intraprediction mode is counted. In FIG. 10, in the case of pixels corresponding to the start point and the end point according to Table 2 among pixels of the labeled input block 100, pixels at P(0,0) and P(3,3) are assigned the same label 6, pixels at P(1,0) and P(3,2) are assigned the same label 1, pixels at P(0,1) and P(2,3) are assigned the same label 1, and pixels at P(0,1) and P(3,1) are assigned the same label 1. In this case, since the direction of a straight line connecting the pixels at P(0,0) and P(3,3), the direction of a straight line connecting the pixels at P(1,0) and P(3,2), and the direction of a straight line connecting the pixels at P(0,1) and P(2,3) are the same as the direction of Mode 4, a mode count Mode Count_{Mode4} of Mode 4 is 3. In addition since the direction of a straight line connecting the pixels at P(1,0) and P(1,3) and the direction of a straight line connecting the pixels at P(2,0) and P(2,3) are the same as the direction of Mode 0, a mode count Mode Count_{Mode0} of Mode 0 is 2. Since the direction of a straight line connecting the pixels at P(0,1) and P(3,1) is the same as the direction of Mode 1, a mode count Mode Count_{Mode1} of Mode 1 is 1.

Similarly, referring to FIG. 11, labels assigned to pixels at predetermined positions in a 5×5 input block are scanned according to the scan table, e.g., Table 1, and if the scanned two pixels have the same label, a corresponding intraprediction mode is counted. In FIG. 11, in the case of pixels corresponding to the start point and the end point according to Table 1 among pixels of the labeled input block 110, pixels at P(0,0) and P(4,4) are assigned the same label 6, pixels at P(2,0) and P(2,4) are assigned the same label 1, and pixels at P(3,0) and P(3,4) are assigned the same label 1. In this case, since the direction of a straight line connecting the pixels at P(0,0) and P(4,4) is the same as the direction of Mode 4, a mode count Mode Count_{Mode4} of Mode 4 is 1. In addition since the direction of a straight line connecting the pixels at P(2,0) and P(2,4) and the direction of a straight line connecting the pixels at P(3,0) and P(3,4) are the same as the direction of Mode 0, a mode count Mode Count_{Mode0} of Mode 0 is 2.

As such, in the exemplary embodiment of the present invention, a mode count of each of the intraprediction modes is calculated by determining whether the same label is assigned to pixels at predetermined positions in the direction of each of the intraprediction modes according to a predetermined scan table.

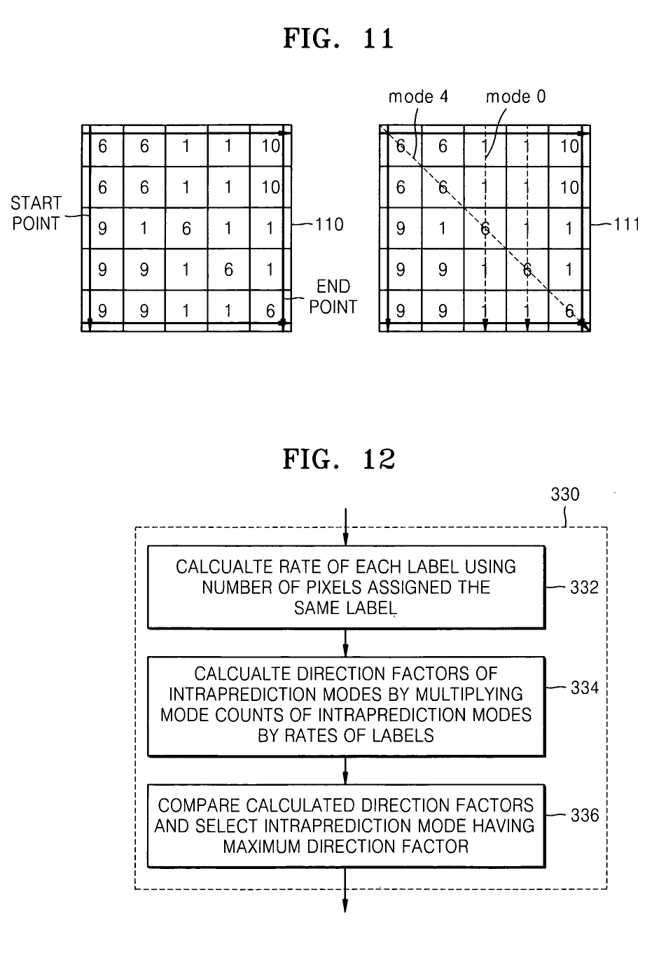

FIG. 12 is a detailed flowchart illustrating operation 330 of FIG. 3.

Operation 330 is intended to decide a prediction mode to be actually applied to intraprediction using the mode count of each of the intraprediction modes calculated in operation 320. To this end, in the exemplary embodiment of the present invention, a predetermined weight is applied to the calculated mode count of each of the intraprediction modes to calculate a direction factor (DF) of each of the intraprediction modes, and the calculated DFs of the intraprediction modes are compared to select an intraprediction mode having the maximum DF.

As the predetermined weight, the rate of a label used in calculation of the mode count of each of the intraprediction modes may be used. In other words, the rate of each label is calculated using the number of pixels having the same label in operation 332. This is because the accuracy of the decision of the optimal intraprediction mode can be improved by applying a high weight to a label assigned to a more number of pixels and a low weight to a label assigned to a less number of pixels. For example, referring back to FIG. 11, the rate of pixels assigned the label 1 used in the calculation of mode counts in the labeled input block 110 is ( 11/25)×100=44%. The rate of pixels assigned the label 6 is ( 7/25)×100=28%.

Next, the mode count of each of the intraprediction modes is multiplied by the rate of each label to calculate the DF of each of the intraprediction modes in operation 334. A DF DF_{Mode N} of an intraprediction mode Mode N is as follows:

DF_{Mode N}=Mode Count_{Mode N}×W (1),

where W is a weight, and the rate of each label is used as the weight as described above. For example, in FIG. 11, the mode count Mode Count_{Mode 0} of Mode 0 is 2, which is calculated from pixels assigned the label 1, and the rate of pixels assigned the label 1 is 44%. In this case, the DF DF_{Mode 0} of Mode 0 is as follows:

DF_{Mode 0}=2×44=88 (2)

In FIG. 11, the mode count Mode Count_{Mode 4} of Mode 4 is 1, which is calculated from pixels assigned the label 6, and the rate of pixels assigned the label 6 is 28%. In this case, the DF DF_{Mode 4} of Mode 4 is as follows:

DF_{Mode 4}=1×28=28 (3)

Next, the calculated DFs of the intraprediction modes are compared and a final intraprediction mode having the maximum DF is selected in operation 336. In FIG. 11, since the DF DF_{Mode 0} of Mode 0 is 88 and the DF DF_{Mode 4} of Mode 4 is 28, Mode 0 is selected as the optimal intraprediction mode for the labeled input block 110 of FIG. 11.

Although intraprediction modes are counted as the same intraprediction mode in calculation of a mode count, they may use pixels assigned different labels. Referring back to FIG. 10, the pixels assigned the label 1 and the pixels assigned the label 6 are used in calculation of the mode count of Mode 4. In this case, a DF is calculated by multiplying the mode count of each of the intraprediction modes by the rate of each label, and DFs having the same intraprediction mode are summed up. Let us consider a case where the DF of Mode 4 is calculated from the labeled input block 100 of FIG. 10. In the labeled input block 100 of FIG. 10, the rate of pixels assigned the label 1 is ( 9/16)×100=56.25% and the rate of pixels assigned the label 6 is ( 4/16)×100=25%. The mode count of Mode 4 is 3, i.e., a sum of 2 from the pixels assigned the label 1 and 1 from the pixels assigned the label 6. In this case, the DF DF_{Mode 4} of Mode 4 is as follows:

DF_{Mode 4}=DF_{Label 1,Mode 4}+DF_{Label 6,Mode 4}=2×56.25+1×25=137.5 (4),

where DF_{Label 1, Mode 4} indicates the DF of Mode 4 based on the pixels assigned the label 1 and DF_{Label 6, Mode 4} indicates the DF of Mode 4 based on the pixels assigned the label 6. In this way, in the case of intraprediction modes counted as the same intraprediction mode, but using pixels assigned different labels, the DF of each of the intraprediction modes is calculated and the DFs of the intraprediction modes are summed up, thereby calculating the DF of a corresponding intraprediction mode. For example, in FIG. 10, since the DF DF_{Mode 1} of Mode 1 is 56.25, the DF DF_{Mode 0} of Mode 0 is 112.5, and the DF DF_{Mode 4} of Mode 4 is 137.5, Mode 4 is selected as the intraprediction mode of the labeled input block 100 of FIG. 10.

For more accurate prediction, modes adjacent to the selected intraprediction mode having the maximum DF may be additionally selected. In this case, by applying only three intraprediction modes among 9 intraprediction modes, the amount of computation required for intraprediction may be reduced when compared to the related art. For example, referring back to FIG. 9, if Mode 4 is decided as the optimal intraprediction mode having the maximum DF, Mode 5 and Mode 6 that are adjacent to Mode 4 may also be selected as intraprediction modes to be actually applied to the input block, thereby improving the accuracy of prediction.

In the exemplary embodiment of the present invention, after the mode count of each of the intraprediction modes is calculated from the labeled input block according to a predetermined scan table, if all the mode counts are 0 or pixels of the labeled input block are assigned the same label, the DC mode is selected as the intraprediction mode to be actually applied to the input block.

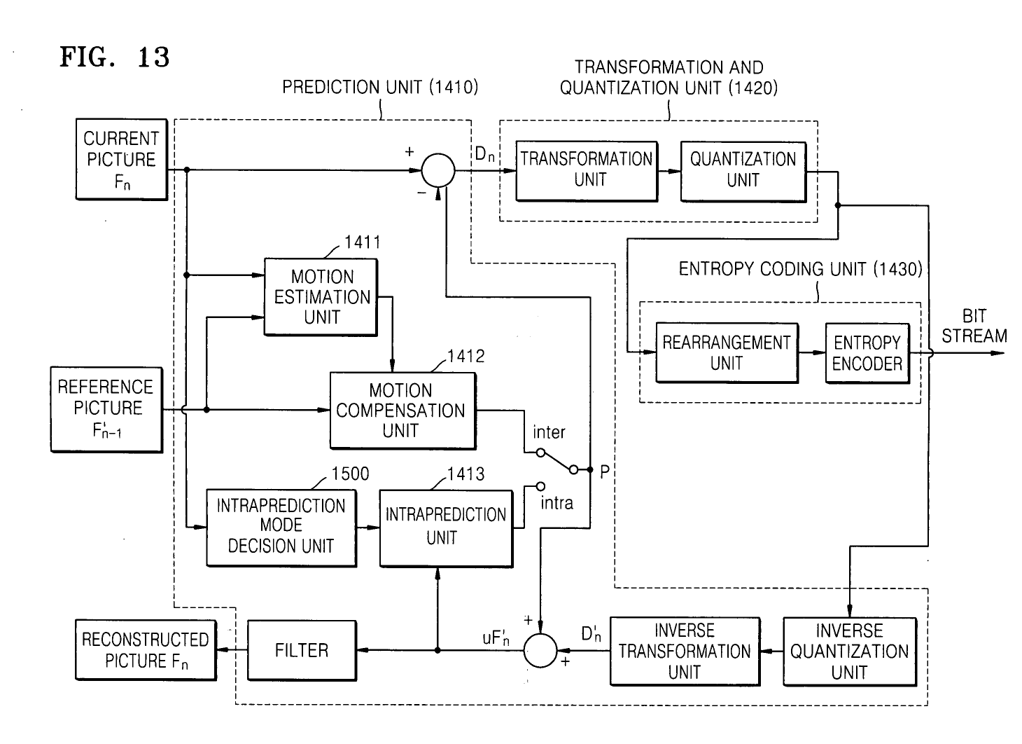

FIG. 13 is a block diagram of a video encoder to which an apparatus for deciding an intraprediction mode according to an exemplary embodiment of the present invention is applied.

Referring to FIG. 13, the video encoder includes a prediction unit 1410, a transformation and quantization unit 1420, and an entropy coding unit 1430.

The prediction unit 1410 performs interprediction and intraprediction. In interprediction, a block of a current picture is predicted using a reference picture that has been encoded, reconstructed and stored in a predetermined buffer. Interprediction is performed by a motion estimation unit 1411 and a motion compensation unit 1412. Intraprediction is performed by an intraprediction unit 1413. An intraprediction mode decision unit 1500 that is the apparatus for deciding an intraprediction mode according to an exemplary embodiment of the present invention is positioned in front of the intraprediction unit 1413. The intraprediction mode decision unit 1500 decides an intraprediction mode to be actually applied to an input block by using the method of deciding an intraprediction mode based on information of the input block and outputs information about the decided intraprediction mode to the intraprediction unit 1413. The intraprediction unit 1413 applies only the intraprediction mode decided by the intraprediction mode decision unit 1500, instead of applying all intraprediction modes, to perform intraprediction.

The transformation and quantization unit 1420 performs transformation and quantization on a residue between a prediction block output from the prediction unit 1410 and the original block, and the entropy coding unit 1430 performs variable length coding on the quantized residue for compression.

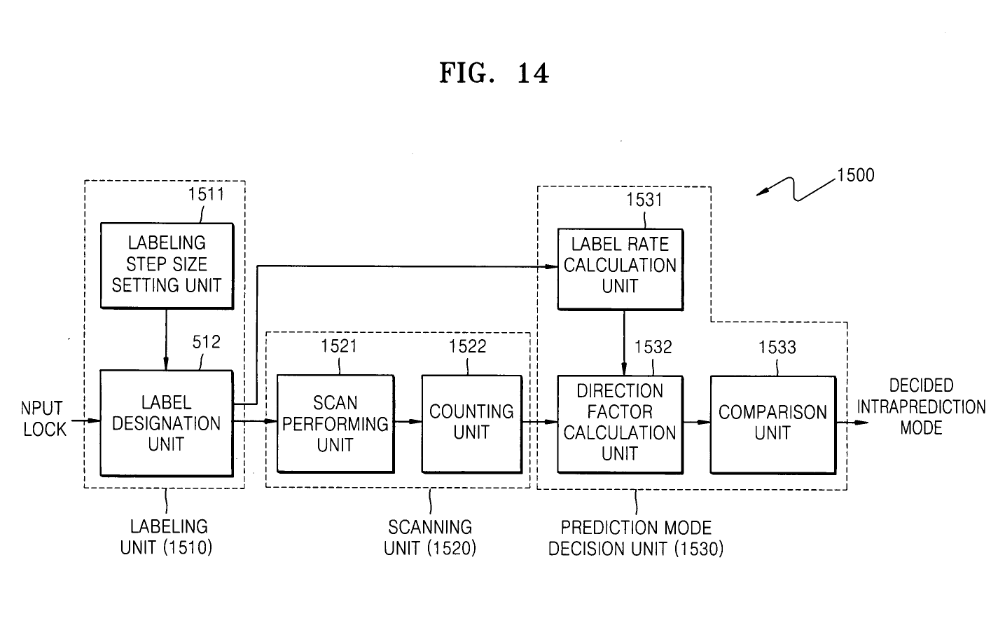

FIG. 14 is a block diagram of the apparatus for deciding an intraprediction mode (intraprediction mode decision unit 1500 illustrated in FIG. 13) according to an exemplary embodiment of the present invention. The intraprediction mode decision unit 1500 includes a labeling unit 1510 that labels pixels of the input block according to pixel values of the pixels of the input block, a scanning unit 1520 that calculates the mode count of each of the intraprediction modes while scanning the labeled input block, and a prediction mode decision unit 1530 that decides an intraprediction mode for the input block using the calculated mode count of each of the intraprediction modes.

The labeling unit 1510 includes a labeling step size setting unit 1511 and a label designation unit 1512. The labeling step size setting unit 1511 sets a labeling step size to assign labels to pixels of the input block, and the label designation unit 1512 divides the pixel values of the pixels of the input block into ranges according to the set labeling step size and designates labels to the divided ranges.

The scanning unit 1520 includes a scan performing unit 1521 and a counting unit 1522. The scan performing unit 1521 scans labels assigned to two pixels corresponding to a start point and an end point according to a predetermined scan table, and the counting unit 1522 counts an intraprediction mode having the same direction as a direction connecting the two pixels, if the labels assigned to the two pixels are the same as each other.

The prediction mode decision unit 1530 includes a label rate calculation unit 1531, a direction factor calculation unit 1532, and a comparison unit 1533. The label rate calculation unit 1531 calculates the rate of each label as a weight for calculating the direction factor of each of the intraprediction modes. The direction factor calculation unit 1532 multiplies the rate of each label to the mode count of each of the intraprediction modes to calculate the direction factor of each of the intraprediction modes. The comparison unit 1533 compares the calculated direction factors, decides an intraprediction mode having the maximum direction factor, and outputs information about the decided intraprediction mode.

In the exemplary embodiment of the present invention, after the mode count of each of the intraprediction modes is calculated from the labeled input block according to a predetermined scan table, if all the mode counts are 0 or pixels of the labeled input block are assigned the same label, the prediction mode decision unit 1530 selects the DC mode as the intraprediction mode to be actually applied to the input block.

As described above, according to an exemplary embodiment of the present invention, instead of performing intraprediction in all available intraprediction modes, only some of them are applied for intraprediction based on the directivity of an input block using pixel information of the input block, thereby reducing computational complexity and the time required for encoding and thus making it easy to implement a real-time video encoder.

Meanwhile, the present invention can also be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over network of coupled computer systems so that the computer-readable code is stored and executed in a decentralized fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of deciding an intraprediction mode of a video, the method comprising:
(a) assigning labels to pixels of an input block according to pixel values of the pixels;
(b) scanning the labeled input block according to a scan table, and calculating mode counts of intraprediction modes by counting the intraprediction mode if the pixels at predetermined positions according to a direction of the intraprediction mode are assigned the same label; and
(c) deciding the intraprediction mode for the input block using the calculated mode counts.

2. The method of claim 1, wherein the assigning comprises:
(a1) setting a labeling step size for dividing the pixel values into ranges;
(a2) dividing the pixel values into the ranges according to the set labeling step size and designating the labels to the ranges; and
(a3) assigning the labels to the pixels of the input block according to the ranges to which the pixel values of the pixels of the input block belong.

3. The method of claim 1, wherein the scanning and calculating comprises:
(b1) scanning a label assigned to a pixel corresponding to a start point in the input block and a label assigned to a pixel corresponding to an end point in the input block according to the direction of the intraprediction mode; and
(b2) calculating the mode counts of the intraprediction modes by counting the intraprediction mode having the same direction as the direction connecting the two pixels corresponding to the start point and the end point, if the labels assigned to the two pixels are the same as each other.

4. The method of claim 3, wherein the pixel corresponding to the start point is located at the first column and row of the input block, and the pixel corresponding to the end point is located at the last column and row of the input block.

5. The method of claim 1, wherein the scan table includes a position of a pixel corresponding to a start point of scanning in the input block and a position of a pixel corresponding to an end point of scanning in the input block according to intraprediction modes available in intraprediction of the input block.

6. The method of claim 1, wherein the deciding comprises:
(c1) calculating direction factors of intraprediction modes by multiplying the calculated mode counts by a weight; and
(c2) comparing the calculated direction factors to select an intraprediction mode having a maximum direction factor.

7. The method of claim 6, further comprising calculating a rate of each of the labels using the number of the pixels assigned the same label, wherein the calculated rate of each of the labels is used as the weight.

8. The method of claim 6, wherein the comparing comprises additionally selecting intraprediction modes that are adjacent to the selected intraprediction mode having the maximum direction factor.

9. The method of claim 1, wherein the deciding comprises selecting a direct current (DC) mode as the intraprediction mode for the input block, if the mode counts of intraprediction modes are all 0 or the pixels of the labeled input block are assigned the same label.

10. The method of claim 1, wherein the labeled input block is scanned according to directions of a vertical mode (Mode 0), a horizontal mode (Mode 1), a diagonal down-left mode (Mode 3), and a diagonal down-right mode (Mode 4).

11. An apparatus for deciding an intraprediction mode of a video, the apparatus comprising:
a labeling unit which assigns labels to pixels of an input block according to pixel values of the pixels;
a scanning unit which scans the labeled input block according to a scan table and calculates mode counts of intraprediction modes by counting the intraprediction mode if the pixels at predetermined positions according to a direction of the intraprediction mode are assigned the same label; and
a prediction mode decision unit which decides the intraprediction mode for the input block using the calculated mode counts.

12. The apparatus of claim 11, wherein the labeling unit comprises:
a labeling step size setting unit which sets a labeling step size for dividing the pixel values into ranges;
a label designation unit which divides the pixel values into the ranges according to the set labeling step size, designates labels to the ranges, and assigns the labels to the pixels of the input block according to the ranges to which the pixel values of the pixels of the input block belong.

13. The apparatus of claim 11, wherein the scanning unit comprises:
a scan performing unit which scans a label assigned to a pixel corresponding to a start point in the input block and a label assigned to a pixel corresponding to an end point in the input block according to the direction of the intraprediction mode; and
a counting unit which calculates the mode counts of intraprediction mode by counting an intraprediction mode having the same direction as the direction connecting the two pixels corresponding to the start point and the end point, if the labels assigned to the two pixels are the same as each other.

14. The apparatus of claim 13, wherein the pixel corresponding to the start point is located at the first column and row of the input block, and the pixel corresponding to the end point is located at the last column and row of the input block.

15. The apparatus of claim 11, wherein the scan table includes a position of a pixel corresponding to a start point of scanning in the input block and a position of a pixel corresponding to an end point of scanning in the input block according to the intraprediction mode available in intraprediction of the input block.

16. The apparatus of claim 11, wherein the prediction mode decision unit comprises:
a direction factor calculation unit which calculates direction factors of intraprediction mode by multiplying the calculated mode counts by a weight; and
a comparison unit which compares the calculated direction factors to select the intraprediction mode having a maximum direction factor.

17. The apparatus of claim 16, wherein the prediction mode decision unit further comprises a label rate calculation unit which calculates a rate of each of the labels using the number of the pixels assigned the same label, and the direction factor calculation unit uses the rate of each of the labels calculated by the label rate calculation unit as the weight.

18. The apparatus of claim 16, wherein the comparison unit additionally selects the intraprediction modes that are adjacent to the selected intraprediction mode having the maximum direction factor.

19. The apparatus of claim 11, wherein the prediction mode decision unit selects a direct current (DC) mode as the intraprediction mode for the input block, if the mode counts of intraprediction modes are all 0 or the pixels of the labeled input block are assigned the same label.

20. The apparatus of claim 11, wherein the labeled input block is scanned according to directions of a vertical mode (Mode 0), a horizontal mode (Mode 1), a diagonal down-left mode (Mode 3), and a diagonal down-right mode (Mode 4).

21. A computer readable recording medium storing a computer program for performing a method of deciding an intraprediction mode of a video, the method comprising:
assigning labels to pixels of an input block according to pixel values of the pixels;
scanning the labeled input block according to a scan table, and calculating mode counts of intraprediction modes by counting the intraprediction mode if the pixels at predetermined positions according to a direction of the intraprediction mode are assigned the same label; and
deciding the intraprediction mode for the input block using the calculated mode counts.
